(19) United States
(12) Patent Application Publication
(10) Pub. No.: US 2008/0189362 A1
(43) Pub. Date: Aug. 7, 2008

(54) SYSTEM, SERVER AND METHOD FOR REALIZING INDIVIDUAL SERVICES FOR SUBSCRIBER

(75) Inventors: Xiaomin SHI, Shenzhen (CN); Jieping ZHONG, Shenzhen (CN)

Correspondence Address: Leydig, Voit & Mayer, Ltd;(for Huawei Technologies Co., Ltd), Two Prudential Plaza Suite 4900, 180 North Stetson Avenue, Chicago, IL, 60601, US

(73) Assignee: HUAWEI TECHNOLOGIES CO., LTD., Shenzhen (CN)

(21) Appl. No.: 12/101,622

(22) Filed: Apr. 11, 2008

Related U.S. Application Data
(63) Continuation of application No. PCT/CN2006/002680, filed on Oct. 12, 2006.

(30) Foreign Application Priority Data
Oct. 14, 2005 (CN) 200510112947.2

(51) Int. Cl. G06F 15/16

(52) U.S. Cl. 709/203

(57) ABSTRACT

Embodiments of the present invention disclose a method for realizing individual services for subscriber, and the method includes an individual service generating process as follows: receiving subscriber service data; matching the subscriber service data and a service rule pre-saved to obtain an individual service of current subscriber, in which the individual service comprises at least one cell service and/or at least one cell service combination. Embodiments of the present invention also disclose a system for realizing individual services for subscriber and an individual service management server corresponding to the method. The individual service of subscribers may be realized flexibly by using the method of the present invention.

The application is a continuation of International Patent Application No. PCT/CN2006/002680, filed Oct. 12, 2006, which claims priority to Chinese patent Application No. 200510112947.2 submitted with the State Intellectual Property Office of P.R.C. on Oct. 14, 2005, entitled “System, Server and Mmethod for Realizing Individual Services for Subscriber,” both the contents of which are incorporated herein by reference in their entirety.

### FIELD OF THE INVENTION

The present invention relates to application service technologies, and in particular to a system and method for realizing individual services for subscriber, and an individual service management server.

### BACKGROUND OF THE INVENTION

Along with the development of the communication technology, application services have also been popularized. Subscribers usually choose various application services needed by themselves according to service lists provided by operators, customize and obtain combinations of their own application services. When a large number of application services or service combinations exist, the customizing process of the subscribers is quite complicated, which makes the service not friendly enough. If the operator is required to customize the application services for each of the subscribers or subscriber groups, service operating cost will be greatly enhanced, and that is not conducive to the maintenance and update of the application service information customized by subscribers. For example, the operator firstly customizes an application service for a subscriber according to an interest of the subscriber, however, the operator can not re-customize application services for the subscriber in time when his interest varies. In addition, when a new service is added, the operator is difficult to determine which subscriber needs the new service.

It can be seen that the prior technologies of realizing application services are very difficult to customize different application services flexibly for subscribers according to characteristics of different subscribers conveniently and effectively. Subscribers often need to personally customize services, which affects the subscribers' satisfactory degree and it is impossible to customize the newest application services for subscribers in time according to changes of subscribers' characteristics. When a new service is produced, operators can not distribute the new service quickly and effectively to the subscribers of requirement, resulting in slow popularization and higher cost.

Therefore, there is an urgent need for a mechanism providing individual services dynamically and flexibly for each subscriber according to characteristics of each subscriber.

### SUMMARY OF THE INVENTION

Embodiments of the present invention are to provide a system and method for realizing individual services for subscriber, and an individual service management server, which can provide individual services for each subscriber according to characteristics of each subscriber automatically.

In order to achieve the above object, the technical solution of embodiments of the present invention is accomplished as follows.

Embodiments of the present invention disclose a system for realizing individual services for subscriber, and the system includes:

an individual service management server adapted to receive subscriber service data from external, save a service rule, and generate individual service information of a subscriber according to the subscriber service data and the service rule.

The system further includes at least one cell service platform, each of which is adapted to bear service logic of at least one cell service. The individual service management server is further adapted to send a service request to cell service platforms in which each cell service making up current individual service is located according to the individual service information. The cell service platform is adapted to receive the service request from the individual service management server, and invoke the service logic of the cell service according to the service request.

The system further includes a cell service registering server adapted to receive cell service information from each cell service platform, save each cell service and a mapping relation between address information of each cell service platform in which each cell service is located, and output the address information of the cell service platform in which the cell service is located to the individual service management server.

The system further includes a subscriber service database, adapted to save the subscriber service data and output the subscriber service data to the individual service management server.

Embodiments of the present invention disclose an individual service management server, and the server includes:

an individual service unit adapted to receive subscriber service data from external, receive a service rule from a service rule unit, and generate individual service information of a subscriber; and

the service rule unit adapted to save the service rule, and send the service rule to the individual service unit.

In the above server, the individual service unit includes an individual service generating module adapted to receive subscriber service data from external, receive the service rule from the service rule unit, and generate the individual service information of the subscriber.

In the above server, the individual service unit further includes an individual service storing module adapted to receive the individual service information from the individual service generating module and save the individual service information.

In the above server, the service rule unit includes a service rule storing module adapted to save the service rule and send the service rule to the individual service unit.

In the above server, the service rule unit further includes a service rule generating module adapted to generate a new service rule according to a configuration command from external or the individual service information received from the individual service unit, and output the new service rule to the service rule storing module.

The above server is further connected with at least one cell service platform, each of which is adapted to bear service logic of at least one cell service and invoke the service logic of the cell service according to a service request. The individual service unit further includes an individual service implementing module adapted to receive the individual service information of the subscriber from the individual service storing module, send the service request to cell service platforms in which each cell service making up current individual service is located according to the individual service information.

Embodiments of the present invention disclose a method for realizing individual services for subscriber, and the method includes an individual service generating process as follows:

receiving subscriber service data; and

matching the subscriber service data with a service rule pre-saved to obtain an individual service of current subscriber, in which the individual service includes at least one cell service and/or at least one cell service combination.

In the above solution, the subscriber service data are a mapping table illustrating a mapping relation between subscriber information and dimension information, in which the dimension information includes dimension information items and content thereof representing various characteristics of subscribers. The service rule includes a dimension mapping table and a subscriber group number mapping table, in which the dimension mapping table is a mapping table illustrating a mapping relation between the dimension information and a subscriber group number, and the subscriber group number mapping table is a mapping table illustrating a mapping relation between an aggregation of subscriber group numbers and the cell service and/or the cell service combination.

The step of matching to obtain the individual service of the current subscriber includes matching the subscriber service data with the dimension mapping table to obtain each subscriber group number, and matching each subscriber group number obtained with the subscriber group number mapping table to obtain the individual service including the cell service and/or the cell service combination.

In the above solution, the service logic of the cell service is born on the cell service platform. After matching to obtain the individual service of the subscriber, the method further includes an individual service implementing process as follows:

obtaining current subscriber information;

determining an individual service corresponding to the subscriber information and address information of cell service platforms in which each cell service making up the individual service is located; and

sending a service request to each cell service platform according to the address information of the cell service platforms determined, invoking service logic of each cell service born on the cell service platform, and sending an implementing result of invoking the service logic to the subscriber.

The method further includes the following steps: the cell service platform registers the cell service and the address information of the cell service whenever the cell service platform bears the service logic of one cell service. The step of determining the address information of the cell service platforms includes: if the address information of the cell service platforms in which all cell services making up current individual service are located is saved, terminating the process of obtaining the address information of the cell service platforms; if the address information of the cell service platforms in which all cell services making up the current individual service are located is not saved, determining cell services locating in the cell service platforms of which the address information is not saved, and obtaining the address information of the cell service platforms in which the cell services are located.

The method further includes a service rule generating process as follows: generating by the individual service management server a new service rule according to a configuration command from a subscriber, or automatically generating the new service rule according to an individual service generated currently.

In the above solution, the subscriber service data are a mapping table illustrating a mapping relation between subscriber information and dimension information, in which the dimension information includes dimension information items and content thereof representing various characteristics of subscribers. The service rule includes a dimension mapping table and a subscriber group number mapping table, in which the dimension mapping table is a mapping table illustrating a mapping relation between the dimension information and a subscriber group number, and the subscriber group number mapping table is a mapping table illustrating a mapping relation between an aggregation of the subscriber group numbers and the cell service and/or the cell service combination.

The step of automatically generating the new service rule includes:

extracting partial or whole subscriber service data;

if the subscriber service data extracted have a same content on the content of the dimension information, determining individual services of subscribers having the same content on the content of the dimension information, and extracting an intersection of cell services and/or cell service combinations between each individual service of the subscribers, forming the new service rule by using the aggregation of subscriber group numbers having the same content on the content of the dimension information and the intersection of the cell services and/or the cell service combinations; and

if the subscriber service data extracted do not have the same content on the content of the dimension information, terminating the process of automatically generating the new service rule.

In the above solution, after the step of generating the new service rule, the method further includes:

if the new service rule generated is in conflict with an existing service rule, judging whether to replace or merge the existing service rule in conflict, and if the new service rule generated is not in conflict with the existing service rule, saving the new service rule; and

if the existing service rule in conflict is to be replaced or merged, replacing or merging the existing service rule in conflict by the new service rule generated currently, and saving the new service rule; if the existing service rule in conflict is not replaced or merged, releasing the new service rule.

In the above solution, the individual service generating process is triggered according to a preset period or triggered when a preset triggering condition is satisfied.

In the above solution, the individual service implementing process is triggered according to a preset periodor triggered when a preset triggering condition is satisfied.

In the above solution, the service rule generating process is triggered according to a preset period or triggered when a preset triggering condition is satisfied.

From the above technical solution, the key of embodiments of the present invention is to receive the subscriber service data from external, save the service rule, and generate the individual service information of the subscriber according to the subscriber service data and the service rule. Therefore, the system and method for realizing individual services for subscriber and the individual service management server provided by embodiments of the present invention can customize different application services flexibly according to characteristics of different subscribers and the changes thereof effectively, so as to simplify greatly the process of the subscriber customizing the application services and facilitating the service management of operators. When a new application service is produced, the operator can distribute the new application service to the subscribers having real requirement quickly so as to accelerate the popularizing process of the new service greatly and lower the popularizing cost, thereby providing a new application service solution for operators and subscribers. This solution has strong practicability and substantial commercial prospects.

### BRIEF DESCRIPTION OF THE DRAWINGS

FIG. 1 is a block diagram illustrating a processing of a system according to an embodiment of the present invention;

FIG. 2 is a structure schematic diagram illustrating a comprehensive service fingerprint system in a system according to an embodiment of the present invention;

FIG. 3 is a flow chart illustrating a main process in a method according to an embodiment of the present invention;

FIG. 4 is a flow chart illustrating an embodiment of an individual service generating process in the embodiment as shown in FIG. 3;

FIG. 5 is a flow chart illustrating an embodiment of a service rule generating process in the embodiment as shown in FIG. 3; and

FIG. 6 is a flow chart illustrating an individual service implementing process in a method according to an embodiment of the present invention.

### DETAILED DESCRIPTION OF THE EMBODIMENTS

The present invention is further detailed in conjunction with the accompanying drawings and embodiments.

The embodiments of the present invention provide a system for realizing individual services for subscriber which at least includes an individual service management server adapted to receive subscriber service data and save a service rule, so as to generate an individual service of current subscriber. The individual service management server may include a service rule unit and an individual service unit. The individual service unit is adapted to receive the subscriber service data from external, read the service rule from the service rule unit, and generate the individual service corresponding to the current subscriber. The service rule unit is adapted to save the service rule and output the service rule to the individual service unit.

The individual service unit may include an individual service generating module and an individual service storing module. The service rule unit may include an service rule storing module adapted to save the service rule, and may further include a service rule generating module adapted to generate the new service rule according to a configuration command from external or according to the individual service information received from the individual service storing module, and send the new service rule to the service rule storing module.

Besides generating the individual service for each subscriber automatically, the individual service management server of the present invention is also responsible for implementing the individual service for the subscriber. At this time, the system of the present invention may further include one or more cell service platforms. The individual service unit in the individual service management server further includes an individual service implementing module. The individual service implementing module is adapted to receive the individual service information of the subscriber from the individual service storing module, determine each cell service making up current individual service according to the individual service information, and send a service request to the cell service platforms in which these cell services are located. Each of the cell service platforms is adapted to bear service logic of one or more cell services, receive the service request from the individual service implementing module, invoke the service logic of the cell service corresponding to the service request, and send an implementing result of the service logic to the subscriber so as to complete the individual service process. Individual service information saved by the individual service storing module includes address information of the cell service platforms in which each cell service making up the individual service is located. Therefore, the individual service implementing module may send the service request directly to the cell service platforms in which each cell service is located according to the individual service information. The so-called cell service is a basic unit which may provide an application service independently, for example, a purely location service and a weather forecasting service, and may also be combined to provide the application service according to a certain rule. The application service formed by combining several cell services is called as cell service combination. For example, the combination, formed by combing the location service and the weather forecasting service according to a certain rule, may provide the subscriber with the weather forecasting of the current location wherever he is.

However, the individual service storing module could not pre-save the address information of the cell service platforms in which all cell services are located. Along with the expansion of the system, the cell service platforms in which the cell services are located may be changed, and a new cell service may be produced. Therefore, the address information of the cell service platforms in which the cell services are located is usually dynamic and may be changed at any time. In view of that, the system of the present invention needs to add a cell service registering server connected with each cell service platform. Whenever the cell service information born on the cell service platform changes, the cell service platform sends its current cell service information to the cell service registering server to complete a registration on the cell service registering server. The individual service generating module needs to be connected with the cell service registering server. When generating an individual service, in each of the cell services making up the individual service, if there are some cell services which are located in the cell service platforms of which address information is unknown to the individual service management server, the individual service generating module extracts, from the cell service registering server, the address information of the cell service platforms in which these cell services are located so as to generate individual service information.

FIG. 1 is a structure schematic diagram illustrating a system according to an embodiment of the present invention. As shown in FIG. 1, the system of the embodiment includes an individual service management server, a cell service registering server and two cell service platforms. Two cell service platforms are expressed as a cell service platform 1 and a cell service platform 2 separately. An individual service unit includes an individual service generating module, an individual service storing module and an individual service implementing module. A service rule unit includes a service rule storing module and a service rule generating module. The illustration of the connection relationship between each entity in FIG. 1 is as follows.

The individual service generating module is adapted to receive subscriber service data from an external entity, read a service rule from the service rule storing module, match the subscribe service data according to the service rule to obtain individual services of each subscriber corresponding to current subscriber service data. At the same time, the individual service generating module may search, from the cell service registering server, for address information of cell service platforms in which partial or all cell services in the individual services obtained currently are located, generate current individual service information and send the individual service information to the individual service storing module.

The service rule generating module is adapted to read individual service information of partial or all subscribers from the individual service storing module, determine same contents between the individual service information of each subscriber, generate a new service rule by a manual or automatic mode, and send the new service rule to the service rule storing module for saving.

The individual service implementing module is adapted to extract the individual service information of the subscribers from the individual service storing module, determine a cell service and/or a cell service combination corresponding to the individual services, and send a service request to the cell service platforms (including the cell service platform 1 and/or the cell service platform 2) in which each cell service is located according to the service rule corresponding to the individual service.

The cell service platform 1 and the cell service platform 2 are adapted to send the cell service information born on themselves separately to the cell service registering server, invoke the service logic of the cell service corresponding to each service request when receiving the service request from the individual service implementing module and obtain an implementing result of the cell service and/or the cell service combination corresponding to current individual service so as to terminate the individual service implementing process.

The cell service registering server is adapted to receive various cell service information from the cell service platform 1 and the cell service platform 2, save a mapping relation between each cell service and the address information of cell service platform in which each cell service is located, receive a search request from the individual service generating module and return address information of a cell service platform in which a cell service corresponding to the search request is located to the individual service generating module.

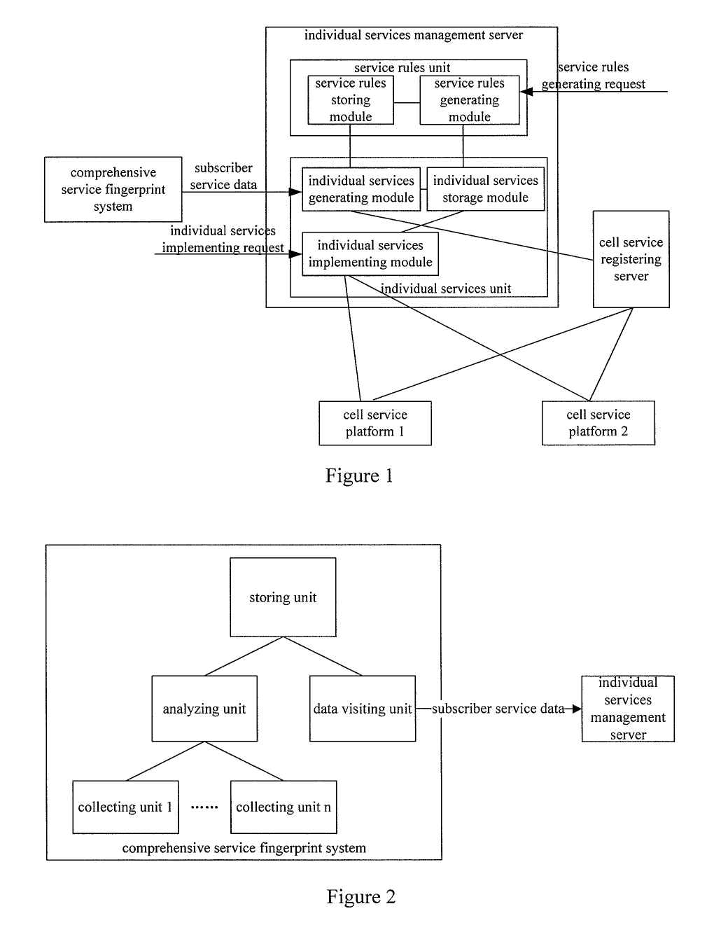

The subscriber service data received by the individual service generating module may come from a subscriber service database for saving the subscriber service data, and may also come from a comprehensive service fingerprint system for generating the subscriber service data automatically. Therefore, the system of the present invention further includes the subscriber service database or the comprehensive service fingerprint system. FIG. 2 is a structure schematic diagram illustrating the comprehensive service fingerprint system in the system according to the embodiment of the present invention. As shown in FIG. 2, the comprehensive service fingerprint system includes one or more collecting units, analyzing units, storing units and data visiting units. One or more collecting units are expressed as a collecting unit 1, . . . , and a collecting unit n separately. The collecting unit 1, . . . , and the collecting unit n are adapted to extract original data representing various characteristics of subscribers from each service node of the communication network separately, for example, extract subscriber's age, gender, customized services, average monthly consumption rate, current location and so on, and send the original data to the analyzing units. Each of the analyzing units is adapted to receive the original data representing various characteristics of the subscribers from each collecting unit, obtain the subscriber service data by analyzing the original data and send the subscriber service data obtained to the storing units. The subscriber service data may be called as subscriber comprehensive service fingerprints. Each of the storing units is adapted to receive and save the subscriber service data, and send the subscriber service data to the data visiting units. Each of the data visiting units is adapted to obtain the subscriber service data by visiting the storing units according to a visiting request from external, and send the subscriber service data to the individual service management server.

It is needed to specially note that the subscriber service data of the present invention can describe a variety of subscriber attributes including as follows: 1. the subscriber own characteristics, such as personal hobby, gender, occupation and so on; 2. the subscriber communication characteristics, such as geographical mobility, various customized application service, service capabilities and so on. The subscriber service data usually exist in a form of a mapping table illustrating a mapping relation between dimension information and subscriber information. The dimension information includes various information items and contents thereof representing various characteristics of the subscriber, and this concept will be mentioned frequently in the following description of methods which is not to be detailed here. In a word, the subscriber service data are data which may embody the characteristics of subscribers using services according to which the individual service needed by subscribers may be determined. With regard to a method of generating the subscriber service data, it is not concern of the present invention, but has already been described in detail in another patent of the applicant. Therefore, the present application will not elaborate further.

Based on the system of the embodiments of the present invention, embodiments of the present invention provide a method for realizing individual services for subscriber. The processing flow of the method in the present invention will be further described together with the accompanying drawings, and the working principle of the system is further explained.

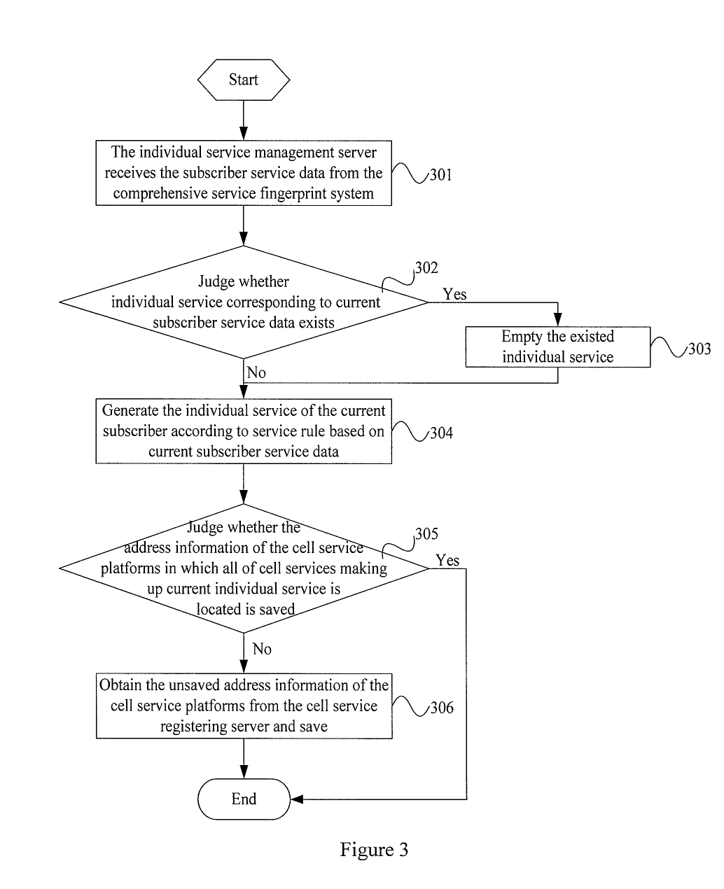

FIG. 3 is a flow chart illustrating a main process n the method according to an embodiment of the present invention. As shown in FIG. 3, specific processing flow includes:

Step 301: the individual service generating module in the individual service management server receives the subscriber service data from the external entity.

The individual service generating module may trigger an individual service generating process according to a preset period for receiving the subscriber service data from the external entity at definite time; or may preset a triggering condition and trigger the individual service generating process when the preset triggering condition is satisfied, so as to trigger the individual service generating module to receive the subscriber service data from the external entity. The triggering condition may be configured as triggering at appointed time, or triggering when the service rule changes, or triggering when a new subscriber accesses, etc, which is not limited by the present invention.

Step 302: the individual service generating module searches in the individual service storing module according to subscriber information in current subscriber service data, so as to judge whether individual service information of the subscriber is saved in the individual service storing module; if the individual service information is saved in the individual service storing module, implement the step 303, and if the individual service information is not saved in the individual service storing module, implement the step 304.

Step 303: the individual service generating module empties the individual service information of the subscriber saved in the individual service storing module.

The above step 302 and step 303 are unnecessary steps for accomplishing the object of the present invention, so the step 302 and step 303 may not be implemented in practical application, i.e. step 304 can be implemented directly after the step 301.

Step 304: the individual service generating module reads each service rule from the service rule storing module, matches the subscriber service data received currently with each read service rule to determine the individual service of current subscriber. The individual service includes at least one cell service and/or at least one cell service combination, so as to generate individual service information of the current subscriber and save the information into the individual service storing module.

The individual service information generated mainly includes information of each cell service making up the individual service, especially the address information of the cell service platform in which each cell service is located. From the description of the above system, the individual service management server may not know all the address information of the cell service platforms in which all cell services are located. For these cell services which are located in the cell service platforms of which the address information is unknown, the cell service information included in the individual service information originally generated by the individual service generating module is an identifier of each of the cell services. The individual service generating module extracts the address information of the cell service platforms in which these cell services locate from the cell service registering server according to identifiers of these cell services, and substitutes the extracted address information of each of the cell service platforms for the identifiers of these cell services in the individual service information so as to obtain final individual service information. In view of that, after the step 304, the method may further include the following.

Step 305: the individual service generating module judges whether the address information of the cell service platforms in which all cell services making up current individual service are located is saved in the individual service storing module; if the address information of the cell service platforms in which all cell services are located is saved in the individual service storing module, terminate current process, otherwise, implement step 306.

For example, when a cell service combination making up current individual service is {a weather forecasting service, a location service and a combining rule of the weather forecasting service and the location service}, it is judged whether address information of cell service platforms, in which weather forecasting service and location service are located, is stored in the individual service generating module.

Step 306: the individual service generating module obtains the address information of the cell service platforms in which these cell services are located by searching in the cell service registering server according to the identifiers of the cell services which are located in the cell service platforms of which address information is unsaved, send the address information of the cell service platforms in which the cell services are located to the individual service storing module, and substitutes corresponding address information of the cell service platforms for identifiers of the cell services in individual service information originally saved in the individual service storing module.

For example, when address information of a cell service platform in which current location service is located is not saved, what is included in the individual service information previously generated is an identifier of the location service. In the present step, the individual service generating module obtains the address information of the cell service platform in which the location service is located by searching the cell service registering server, and substitutes the obtained address information of the cell service platform in which the location service is located for the identifier of the location service in the individual service information.

The individual service generating process of the step 304 is the key step of the above main process of the method in the present invention. For the individual service generating process, the step of matching between the subscriber service data with the service rule is crucial. In order to clarify a method of matching between the subscriber service data with the service rule more, data structures of the subscriber service data and the service rule are described as follows.

As can be seen from the above, the subscriber service data usually exist in a form of a mapping table illustrating the mapping relation between dimension information and subscriber information, such as the following table 1.

TABLE 1

subscriber information

| dimension information | subscriber A | subscriber B | . . . |
|---|---|---|---|
| . . . | . . . | . . . | . . . |
| hobby | outdoor sports | outdoor sports | . . . |
| geographical mobility | low | high | . . . |
| . . . | . . . | . . . | . . . |

The service rule also usually exists in a form of a service rule table which may include two sub-tables:

1. A dimension mapping table

The dimension mapping table which is a mapping table illustrating a mapping relation between dimension information and subscriber group number, which may map the dimension information in the subscriber service data to each subscriber group number. The subscriber group number is a serial number of a subscriber group, and the subscriber group is an aggregation of subscribers sharing the same dimension information in one or more dimension information items. For example, the subscriber A and the subscriber B in the table 1 share the same content “outdoor sports” in the dimension information item “hobby”, so the subscriber A and the subscriber B belong to a same subscriber group in the dimension information item “hobby”, and have a same subscriber group number.

The following table 2 is an example of the dimension mapping table. By matching the subscriber service data shown in Table 1 with the dimension mapping table shown in Table 2, it can be obtained that the group number of the subscriber A is N and M, while the group number of the subscriber B is N and M+1.

TABLE 2

| dimension | dimension | subscriber |
|---|---|---|
| information item | information content | group number |
| . . . | . . . | . . . |
| hobby | outdoor sports | N |
| . . . | . . . | . . . |
| geographical mobility | low | M |
| geographical mobility | high | M+1 |
| . . . | . . . | . . . |

2. A subscriber group number mapping table

The subscriber group number mapping table is a mapping table illustrating a mapping relation between aggregations of subscriber group numbers and cell services and/or cell service combinations, which may map the aggregation of subscriber group numbers obtained by the mapping of the dimension mapping table to the cell services and/or the cell service combinations. For example, in the group number mapping table shown in following Table 3, a combining rule prescribes how to invoke between cell services involved.

TABLE 3

| aggregation | |
|---|---|
| of subscriber | |
| group numbers | cell services and cell service combinations |
| . . . | . . . |
| intersection | aggregation of cell service: {weather forecasting |
| of N and M | service, location service} |
| (N&&M) | combining rule: |
| | {<method> parameter is empty; |
| | <return value> weather forecasting service} |
| intersection | aggregation of cell service: {weather forecasting |
| of N and M+1 | service, location service} |
| (N&&M + 1) | combining rule: |
| | {<method> make the location service as the parameter |
| | and transmit it to the weather forecasting service; |
| | <return value> weather forecasting service where the |
| | subscriber is located} |
| | (For example, if the current subscriber moves to |
| | Shanghai, the weather forecasting service of Shanghai |
| | is sent to the subscriber) |
| . . . | . . . |

If a result obtained from mapping the above Table 1 with Table 2, “the group number of the subscriber A is N and M, while the group number of the subscriber B is N and M+1”, is adopted to match the Table 3, cell services and/or cell service combinations of the subscriber A and the subscriber B can be obtained, i.e. individual services of the subscriber A and the subscriber B including {weather forecasting service} of the individual service of the subscriber A and {combination of weather forecasting service and location service} of the individual service of the subscriber B. Because the <return value> in the combining rule of the subscriber A is the weather forecasting service, i.e. the location service has no effect, so the individual service of the subscriber A is only the weather forecasting service. The <return value> in the combining rule of the subscriber B is the weather forecasting service invoking the location service, so the individual service of the subscriber B is the combination of the weather forecasting service and the location service.

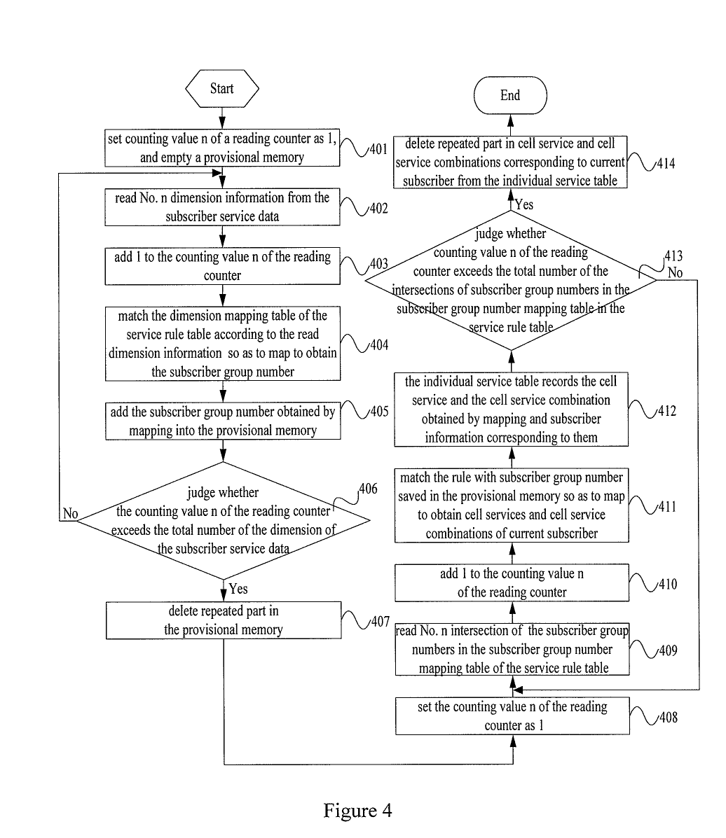

Based on the method of matching the subscriber service data and the service rule, principle of the individual service generating process in the method of the present invention will be further described together with FIG. 4.

FIG. 4 is a flow chart illustrating the individual service generating process in the embodiment as shown in FIG. 3. The executor of the process is the individual service generating module. As shown in FIG. 4, the process includes the following.

Step 401: set counting value n of a reading counter as 1, and empty a provisional memory for buffering the subscriber group number.

Step 402˜step 403: read content of No. n dimension information item from the subscriber service data, and add 1 to the counting value n of the reading counter.

Step 404: match the dimension mapping table of the service rule table according to the content of No. n dimension information item read so as to map to obtain the subscriber group number.

Step 405: add the subscriber group number obtained by mapping in step 404 into the provisional memory.

Step 406: judge whether the counting value n of the reading counter exceeds the total number of the dimension information items of the subscriber service data, if the counting value n of the reading counter exceeds the total number of the dimension information items of the subscriber service data, perform step 407, and if the counting value n of the reading counter doesn't exceed the total number of the dimension information items of the subscriber service data, return to the step 402.

Step 407: delete a repeated part in each subscriber group number buffered in the provisional memory. Because a same subscriber group number may be obtained by matching according to the content of different dimension information items, the subscriber group number saved in the provisional memory may be repeated. Therefore, the present step needs delete repeated subscriber group number so as to avoid redundant operations.

Step 408: set the counting value n of the reading counter as 1.

Step 409˜step 410: read No. n aggregation of subscriber group number in the subscriber group number mapping table of the service rule table, and add 1 to the counting value n of the reading counter.

Step 411: match the aggregation of the subscriber group number with each subscriber group number saved currently in the provisional memory so as to map to obtain the individual service of current subscriber, which is a cell service and/or a cell service combination.

Step 412: record individual service information obtained by mapping in the step 411 into the individual service storing module.

The individual service information saved in the individual service storing module also usually exists in a form of an individual service information table. Each piece of individual service information which is recorded by the individual service information table includes: subscriber information, information of each cell service making up the individual service of the subscriber, the combining rule of the cell services and so on. The individual service information table is shown in Table 4:

TABLE 4

| Subscriber | | |
|---|---|---|
| information | cell service information | combining rule |
| . . . | . . . | . . . |
| the subscriber A | cell service 1 information | combining rule of cell |
| | cell service 2 information | service 1 information and |
| | | cell service 2 information |
| . . . | . . . | . . . |

The above subscriber information is usually a subscriber identifier. The cell service information is usually address information of the cell service platform in which the cell service is located. The combining rule is invoking order, passed parameters, etc, when invoking the cell service combination.

Step 413: judge whether the counting value n of the reading counter exceeds the total number of the aggregations of the subscriber group numbers in the subscriber group number mapping table in the service rule table, if the counting value n of the reading counter exceeds the total number of the aggregations of the subscriber group numbers, perform step 414, and if the counting value n of the reading counter doesn't exceed the total number of the aggregations of the subscriber group numbers, return to the step 409.

Step 414: Delete a repeated part in cell services and cell service combinations corresponding to the individual service of current subscriber from the individual service information table. For example, the cell service 1 of the subscriber A may be obtained many times by matching in the step 411. Therefore, the present step needs to delete repeated cell service 1.

The flow chart shown in FIG. 4 is a process of generating the individual service of one subscriber according to the data of one subscriber service, the flow chart shown in FIG. 4 is implemented according to the data of each subscriber. In addition, there are several methods for obtaining the individual service of the subscriber by matching the subscriber service data and the service rule. According to the different data structure of the subscriber service data and the service rule, the specific method of matching the two is changed. One preferred embodiment is provided only. The data structure of the subscriber service data and the service rule, and the specific method of matching the subscriber service data and the service rule are not limited.

The service rule in the present invention for generating individual service is usually pre-saved in the service rule storing module. The service rule may be saved statically and renewed dynamically. System operator could manually implement operations on the service rule, for example, implementing an adding operation, a modifying operation, a deleting operation and so on. The system of the present invention may also generate new service rules automatically by analyzing condition of current individual service of a plurality of subscribers.

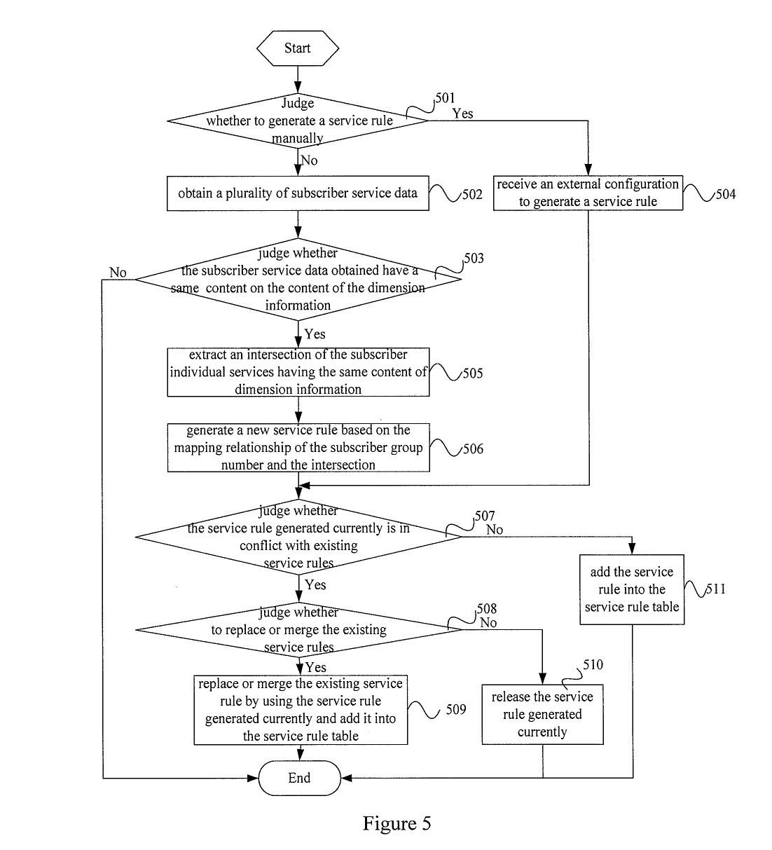

FIG. 5 is a flow chart illustrating the service rule generating process in the embodiment shown in FIG. 3. The executor of the process is the service rule generating module. The service rule generating module may trigger the service rule generating process according to a preset period, or may preset triggering condition and trigger the service rule generating process when the preset triggering condition is satisfied. The triggering condition may be configured as triggering at appointed time, or triggering when receiving a service rule generating request and so on. As shown in FIG. 5, after the service rule generating process is triggered, the specific process includes:

Step 501: judge whether to generate a service rule manually; if the service rule is generated manually, perform step 504, and if the service rule is not generated manually, perform step 502.

Step 502: obtain partial or whole subscriber service data.

Step 503: judge whether the subscriber service data obtained have a same content on the content of the dimension information, if yes, perform step 505, otherwise, terminate the current process.

For example, from each subscriber service data obtained, it can be found that the subscriber A, the subscriber B and the subscriber C share similarities in the dimension information items “gender” and “hobby”, which are “man” in gender and “football” in hobby, so the step 505 may further be performed.

Step 504: receive a configuration command from an external subscriber, extract a service rule from the configuration command, and perform step 507.

Step 505: determine the individual service information of subscribers sharing similarities on the dimension information mentioned in the step 503, and extract an intersection of cell services and/or cell service combinations in the individual service information of these subscribers. For example, when the individual service of the subscriber A and the subscriber B both include the cell service “Football Express”, the intersection of their cell services and/or cell service combination is “Football Express”.

Step 506: based on the intersection of cell services and/or cell service combinations obtained by the step 505, generate a new service rule, which may be expressed as the aggregation of subscriber group numbers sharing similarities on the dimension information mentioned in the step 503 and the intersection of the cell services and/or the cell service combinations mentioned in the step 505, which is corresponding to the aggregation of the subscriber group numbers.

Step 507: judge whether the service rule generated currently is in conflict with service rules originally saved in the service rule storing module, if yes, perform step 508, otherwise, perform step 511.

Conflicts of the service rules are explained by the following example: A service rule that an aggregation {A, B, C} of subscriber group number is corresponding to the cell service and/or cell service combination, aggregation 1, is generated currently, while an existing service rule is that the aggregation {A, B, C} of subscriber group number is corresponding to the cell service and/or cell service combination, aggregation 2, and then the conflict happens.

Step 508: judge whether to replace or merge the existing service rule, if yes, perform step 509, otherwise, perform step 510.

Whether to replace or merge the existing service rule could be determined according to a pre-specified parameter. The merging of service rules may be explained by the following example: a new service rule that an aggregation {A, B, C} of subscriber group number is corresponding to the cell service and the cell service combination, aggregation 1, is generated, while a existing service rule is that the aggregation {A, B, C} of subscriber group number is corresponding to the cell service and the cell service combination, aggregation 2, then the aggregation 1 and 2 are merged, and current service rule is changed into that the aggregation {A, B, C} of subscriber group number is corresponding to the aggregation 1 and the aggregation 2.

Step 509: replace or merge the existing service rule by using the service rule generated currently, add it into the service rule table, and terminate the current process.

Step 510: release the service rule generated currently, and terminate the current process.

Step 511: add the service rule generated currently into the service rule table.

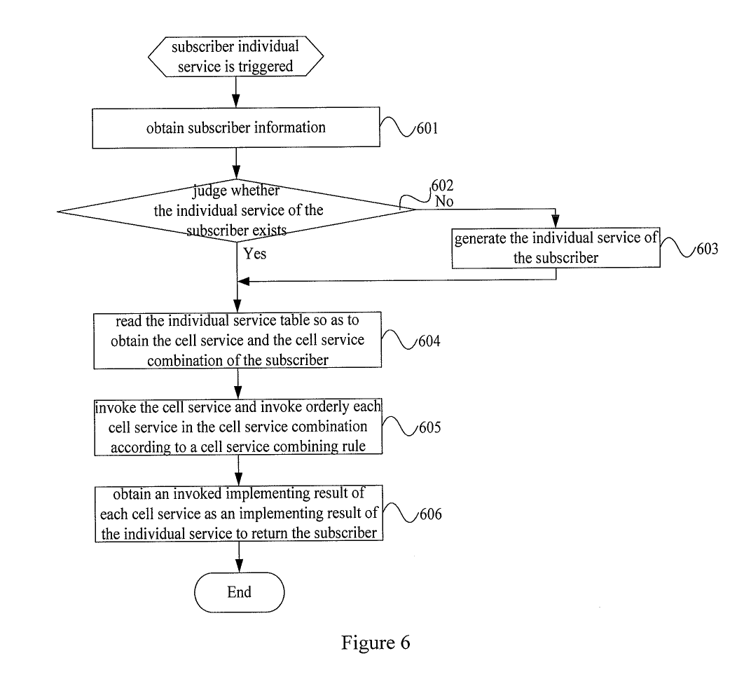

After the individual service is generated for subscribers according to the flow as shown in FIG. 3 and FIG. 4, the individual service may be employed by subscribers. FIG. 6 is a flow chart illustrating the individual service implementing process in the method according to an embodiment of the present invention. The executor of the individual service implementing process is the individual service implementing module. The individual service implementing module can trigger the individual service implementing process according to a preset period, or can preset a triggering condition and trigger the individual service implementing process when the preset triggering condition is satisfied. The triggering condition may be configured as triggering at appointed time, or triggering when receiving a individual service for subscriber implementing request and so on. As shown in FIG. 6, after the individual service implementing process is triggered, the process includes:

Step 601: the individual service implementing module obtains subscriber information of the individual service triggered currently.

The subscriber information may be obtained from the individual service for subscriber implementing request, or from preset individual service implementing information, which is not limited by the present invention.

Step 602: search individual service information saved in the individual service storing module according to the subscriber information obtained, judge whether the individual service of the subscriber exists; if the individual service of the subscriber exists, perform step 604, and if the individual service of the subscriber does not exist, perform step 603.

Step 603: generate the individual service of the subscriber. The process is shown in FIG. 4 and is not to be further described here.

The step 602 and step 603 are not necessary. The step 602 and step 603 may be not performed if it can be ensured that all of the individual services triggered exist in realization, i.e. the step 604 may be performed directly after step 601.

Step 604: read the individual service information saved in the individual service storing module according to the subscriber information so as to obtain the individual service information corresponding to the subscriber. The individual service information is information of each cell service and/or each cell service combination.

Step 605: sent a service request to service platform in which each cell service is located according to the information of each cell service and/or each cell service combination obtained in the step 604. An interface of service logic of each cell service born on the service platform is invoked according to the combining rule in the information of cell service combination. For the cell service combination, a service logic interface of each cell service making up the cell service combination is invoked in a certain order according to the combining rule.

The method of how to invoke the service logic interface of cell services according to combining rule is a well-known technology which is not to be further described here.

Step 606: obtain an implementing result of invoking each cell service and/or cell service combination in the step 605. Return the result as an implementing result of the individual service to the subscriber.

The individual service generating process and the individual service implementing process of the present invention are illuminated by taking another example.

1. The subscriber service data of the subscriber C and the subscriber D are shown in Table 5.

TABLE 5

subscriber information

| dimension information | subscriber C | subscriber D | . . . |
|---|---|---|---|
| . . . | . . . | . . . | . . . |
| hobby | online game | online game | . . . |
| ARPU value | low | high | . . . |
| . . . | . . . | . . . | . . . |

2. The dimension mapping table and the subscriber group number mapping table in the service rule table are as follows:

1). Dimension Mapping Table

| dimension | dimension | subscriber |
|---|---|---|
| information item | information content | group number |
| . . . | . . . | . . . |
| hobby | online game | X |
| . . . | . . . | . . . |
| ARPU value | Low | Y |
| ARPU value | High | Y+1 |
| . . . | . . . | . . . |

2). Subscriber Group Number Mapping Table

It can be seen that streaming media services include two interfaces, one is an interface with small data flow and low definition and another is an interface with large data flow and high definition.

| aggregation | |
|---|---|
| of subscriber | |
| group number | cell service and cell service combination |
| . . . | . . . |
| X&&Y | cell service: {streaming media service, online three |
| | kingdoms game service} |
| | combining rule: |
| | {<method> the online three kingdoms game service |
| | invokes the interface with small data flow and low |
| | definition of the streaming media service; |
| | <return value> the online three kingdoms game service |
| | with small data flow and low definition} |
| | (the expenditure of subscribers could be greatly saved |
| | under the condition of charging based on flow) |
| X&& (Y + 1) | cell service: {streaming media service, online three |
| | kingdoms game service} |
| | combining rule: |
| | {<method> the online three kingdoms game service |
| | invokes the interface with large data flow and high |
| | definition of the streaming media service; |
| | <return value> the online three kingdoms game with |
| | service large data and flow high definition} |
| | (a good subscriber experience is given for subscribers) |
| . . . | . . . |

3. The individual service of the subscriber C and the subscriber D could be obtained by matching the table 5 with the service rule table. The individual service of the subscriber C is “the online three kingdoms game service with small data flow and low definition”, and the individual service of the subscriber D is “the online three kingdoms game service with large data flow and high definition.” The individual service of the subscriber C and the subscriber D is saved in an individual service information table and then the subscriber C and the subscriber D are informed of their own individual service.

4. When the subscriber C employs its own individual service “the online three kingdoms game service with small data flow and low definition”, the individual service management server firstly obtains a method of making up “the online three kingdoms game service with small data flow and low definition” by searching in the individual service information table. According to the combining rule to the cell services of “online three kingdoms game service” and “streaming media service”, the individual service management server invokes service logic of “online three kingdoms game service”, and then the service logic of the “online three kingdoms game service” visits the interface with small data flow and low definition of the “streaming media service”, so as to obtain an implementing result of the “online three kingdoms game service with small data flow and low definition” of the subscriber C, and sends the implementing result to the subscriber C. When the subscriber D employs its own individual service “online three kingdoms game service with large data flow and high definition,” the individual service management server firstly obtains a method of composing “online three kingdoms game service with large data flow and high definition” by searching in the individual service information table. And then, according to the provision of the combining rule to the cell services, “online three kingdoms game service” and “streaming media service”, the individual service management server invokes service logic of the “online three kingdoms game service,” and then the service logic of “online three kingdoms game service” visits the interface with large data flow and high definition of the “streaming media service”, so as to obtain an implementing result of “online three kingdoms game service with large data flow and high definition” of the subscriber D, and sends the implementing result to the subscriber D.

In addition, embodiments of the present invention also provide an individual service management server. A specific composition and operating principle of the individual service management server have been described in detail in the system, which are unnecessary to be described again.

In summary, individual services for subscriber can be generated automatically according to the subscriber service data by applying the system, method and server of the present invention. Different application services can be provided for different subscribers. Subscribers do not need to select the aggregations of application services required by themselves manually from a large number of application services and possible application service combinations, so that operators may quickly and efficiently provide application services for subscribers having real requirement. And it is conducive to the popularity of new services. Once a new service is produced, the new service may be customized automatically for specific subscriber group. Intelligentization of the network side could be accomplished in the aspect of customizing application services for subscribers by implementing the present invention. The cost of developing application services by operators could be greatly reduced, and an unprecedented experience of personalized service is given to subscribers. The proposal of the present invention may be a great step forward in the development of application services.

Though illustration and description of the present disclosure have been given with reference to embodiments thereof, it should be appreciated by persons of ordinary skill in the art that various changes in forms and details can be made without deviation from the scope of this disclosure, which are defined by the appended claims.

What is claimed is:

1. A system for realizing individual service for subscriber, comprising:
an individual service management server adapted to receive subscriber service data from external, save a service rule, and generate individual service information of a subscriber according to the subscriber service data and the service rule.

2. The system according to claim 1, wherein the system further comprises at least one cell service platform adapted to bear service logic of at least one cell service, receive a service request from the individual service management server, and invoke the service logic of the cell service according to the service request;
the individual service management server is further adapted to send the service request to cell service platforms, in which each cell service making up current individual service is located according to the individual service information.

3. The system according to claim 2, wherein the system further comprises: a cell service registering server adapted to receive cell service information from each cell service platform, save a mapping relation between each cell service and address information of the cell service platform in which each cell service is located, and output the address information of the cell service platform in which the cell service is located to the individual service management server.

4. The system according to claim 1, wherein the system further comprises a subscriber service database adapted to save the subscriber service data and output the subscriber service data to the individual service management server.

5. The system according to claim 1, wherein the system further comprises a comprehensive service fingerprint system comprising at least one collecting unit, analyzing unit, data visiting unit and storing unit;
the collecting unit is adapted to collect original data representing various characteristics of subscribers from each of service nodes in a communication network and output the original data to the analyzing unit;
the analyzing unit is adapted to obtain the subscriber service data by analyzing the original data received and representing various characteristics of the subscribers, and send the subscriber service data to the storing unit;
the storing unit is adapted to save the subscriber service data from the analyzing unit, and output the subscriber service data to the data visiting unit; and
the data visiting unit is adapted to receive the subscriber service data from the storing unit and output the subscriber service data to the individual service management server.

6. An individual service management server, comprising:
an individual service unit adapted to receive subscriber service data from external, receive a service rule from a service rule unit, and generate individual service information of a subscriber; and
the service rule unit adapted to save the service rule, and send the service rule to the individual service unit.

7. The server according to claim 6, wherein the individual service unit comprises an individual service generating module adapted to receive the subscriber service data from external, receive the service rule from the service rule unit, and generate the individual service information of the subscriber.

8. The server according to claim 7, wherein the individual service unit further comprises an individual service storing module adapted to receive the individual service information from the individual service generating module and save the individual service information.

9. The server according to claim 6, wherein the service rule unit comprises a service rule storing module adapted to save the service rule, and send the service rule to the individual service unit.

10. The server according to claim 9, wherein the service rule unit further comprises a service rule generating module adapted to generate a new service rule according to a configuration command from external or the individual service information received from the individual service unit, and output the new service rule to the service rule storing module.

11. The server according to claim 7 wherein:
the server is further connected with at least one cell service platform adapted to bear service logic of at least one cell service and invoke the service logic of the cell service according to a service request; and
the individual service unit further comprises:
an individual service implementing module adapted to receive the individual service information of the subscriber from the individual service storing module, send the service request to cell service platforms, in which each cell service making up current individual service is located according to the individual service information.

12. A method for realizing individual services for subscriber, comprising an individual service generating process as follows:
receiving subscriber service data; and
matching the subscriber service data and a service rule pre-saved to obtain an individual service of current subscriber, wherein the individual service comprises at least one cell service and/or at least one cell service combination.

13. The method according to claim 12, wherein the subscriber service data is a mapping table illustrating a mapping relation between subscriber information and dimension information, wherein the dimension information is a dimension information item and content thereof representing various characteristics of subscribers; the service rule comprises a dimension mapping table and a subscriber group number mapping table, wherein the dimension mapping table is a mapping table illustrating a mapping relation between the dimension information and a subscriber group number, and the subscriber group number mapping table is a mapping table illustrating a mapping relation between an aggregation of subscriber group numbers and the cell service and/or the cell service combination; and
the matching the subscriber service data and a service rule pre-saved to obtain the individual service of the current subscriber comprises:
matching the subscriber service data and the dimension mapping table to obtain each subscriber group number; and
matching each obtained subscriber group number and the subscriber group number mapping table to obtain the individual service comprising the cell service and/or the cell service combination.

14. The method according to claim 12, wherein the service logic of the cell service is born on a cell service platform; and
after matching to obtain the individual service of the subscriber, the method further comprises an individual service implementing process as follows:
determining address information of cell service platforms in which each cell service making up the obtained individual service is located; and
sending a service request to each cell service platform according to the address information of the cell service platforms determined, invoking service logic of each cell service born on the cell service platform, and sending an implementing result of invoking the service logic to the subscriber.

15. The method according to claim 14, wherein the method further comprises:
registering, by the cell service platform, the cell service and the address information of the cell service whenever the cell service platform bears the service logic of one cell service.

16. The method according to claim 12, wherein the method further comprises a service rule generating process as follows:
generating, by an individual service management server, a new service rule according to a configuration command from a subscriber, or automatically generating the new service rule according to an individual service generated currently.

17. The method according to claim 16, wherein the subscriber service data are a mapping table illustrating a mapping relation between subscriber information and dimension information, wherein the dimension information is a dimension information item and content thereof representing various characteristics of subscribers; the service rule comprises a dimension mapping table and a subscriber group number mapping table, wherein the dimension mapping table is a mapping table illustrating a mapping relation between the dimension information and a subscriber group number, and the subscriber group number mapping table is a mapping table illustrating a mapping relation between an aggregation of the subscriber group numbers and the cell service and/or the cell service combination; and
the step of automatically generating the new service rule comprises:
extracting partial or whole subscriber service data;
if the subscriber service data extracted have a same content on the content of the dimension information, determining individual services of subscribers having the same content on the content of the dimension information, and extracting an intersection of cell services and/or cell service combinations between each individual service of the subscribers, forming the new service rule by using the aggregation of the subscriber group numbers having the same content on the content of the dimension information and the intersection of the cell services and/or the cell service combinations.

18. The method according to claim 16, wherein after generating the new service rule, the method further comprises:
if the new service rule is not in conflict with the existing service rule, saving the new service rule, if the new service rule is in conflict with an existing service rule, judging whether to replace or merge the existing service rule in conflict; and
if the existing service rule in conflict is replaced or merged, replacing or merging the existing service rule in conflict by the new service rule, and saving the new service rule; if the existing service rule in conflict is not replaced or merged, releasing the new service rule.

19. The method according to claim 12, wherein the individual service generating process is triggered according to a preset period or triggered when a preset triggering condition is satisfied.

20. The method according to claim 14, wherein the individual service implementing process is triggered according to a preset period or triggered when a preset triggering condition is satisfied.

21. The method according to claim 16, wherein the service rule generating process is triggered according to a preset period or triggered when a preset triggering condition is satisfied.
